(19) United States
(12) Patent Application Publication
(10) Pub. No.: US 2021/0165723 A1
(43) Pub. Date: Jun. 3, 2021

(54) Graphical Indicator With History

(71) Applicant: Computational Systems, Inc., Knoxville, TN (US)

(72) Inventors: Anthony J. Hayzen, Knoxville, TN (US); Christopher G. Hilemon, Knoxville, TN (US)

(73) Assignee: Computational Systems, Inc., Knoxville, TN (US)

(21) Appl. No.: 16/701,697

(22) Filed: Dec. 3, 2019

(51) Int. Cl. G06F 11/34; G06T 11/20

(52) U.S. Cl. CPC G06F 11/3409; G06T 11/206

(57) ABSTRACT

A method of presenting data, by receiving data from a data source, and storing the data on a non-transient, computer-readable storage medium. A current key performance indicator is calculated from the data, and is added to a file of historical key performance indicators that is stored on the non-transient, computer-readable storage medium/The current key performance indicator is read from the non-transient, computer-readable storage medium, and presented in a first graphical image. The historical key performance indicators are read from the non-transient, computer-readable storage medium, and presented in a second graphical image. The presentation of the current key performance indicator is linked to the presentation of the historical key performance indicators in a composite interface element, such that when a historical position is selected in the second graphical image, the first graphical image depicts a key performance indicator that was current at that historical position.

### FIELD

This invention relates to the field of industrial engineering. More particularly, this invention relates to providing an engineer with selectively interactive linked presentations of current status and historical status of machine health key performance indicators (KPIs).

### INTRODUCTION

Large industrial installations have many machines that need to be kept in good repair. Machine health science is a branch of industrial engineering that concerns itself with monitoring and maintaining the proper operation of those machines. As a part of this effort, a variety of different sensors are used to gather information about the operation of each machine. In a modern environment, this data gathering process produces an amount of machine information that can become overwhelming.

Certain high-level data streams have been identified as containing information that provides a good overview of machine health, and when they indicate a problem, other data streams can be investigated to determine the exact nature of the problem. These high-level data streams are generally referred to as key performance indicators (KPIs). By staying aware of the KPIs, an engineer can have a reasonable understanding of the general machine health within his field of responsibility.

However, data streams are not static, and they change over time. Having a current value presented as a KPI—while helpful—does not tell the entire story of the health of one or more machines. Conversely, the history of the KPI does not tell the engineer what is happening at that very moment. Thus, even when simplifying data presentation with the use of KPIs, an engineer might not be able to discern the important aspects of general machine health.

What is needed, therefore, is a system that tends to reduce issues such as those described above, at least in part.

### SUMMARY

The above and other needs are met by a method of presenting data, by receiving data from a data source, and storing the data on a non-transient, computer-readable storage medium. A current key performance indicator is calculated from the data, and is added to a file of historical key performance indicators that is stored on the non-transient, computer-readable storage medium. The current key performance indicator is read from the non-transient, computer-readable storage medium, and presented in a first graphical image. The historical key performance indicators are read from the non-transient, computer-readable storage medium, and presented in a second graphical image. The presentation of the current key performance indicator is linked to the presentation of the historical key performance indicators in a composite interface element, such that when a historical position is selected in the second graphical image, the first graphical image depicts a key performance indicator that was current at that historical position.

In various embodiments according to this aspect of the invention, the data is at least one of vibration, pressure, temperature, volume, speed, sound, and flow. In some embodiments, the key performance indicator is at least one of machines in alert, machine faults, journal entries, machine configurations, alert limit recommendations, and routes. In some embodiments, the composite interface element depicts a selection of key performance indicator statuses. In some embodiments, the first graphical image is a donut chart. In some embodiments, the second graphical image is a stacked trend chart. In some embodiments, the method is embodied in a portable vibration analyzer.

According to another aspect of the invention there is described a non-transitory, computer-readable storage medium having stored thereon a computer program having a set of instructions for causing a computer to perform the method as described above. According to yet another aspect of the invention there is described a computerized apparatus that is configured to perform the method as described above.

### DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIGS. 1-6 depict graphical composite interface elements according to various embodiments of the present invention.

FIG. 7 is a flow chart of a method for depicting graphical composite interface elements according to an embodiment of the present invention.

FIG. 8 is a function block diagram of an apparatus for depicting graphical composite interface elements according to an embodiment of the present invention.

### DESCRIPTION

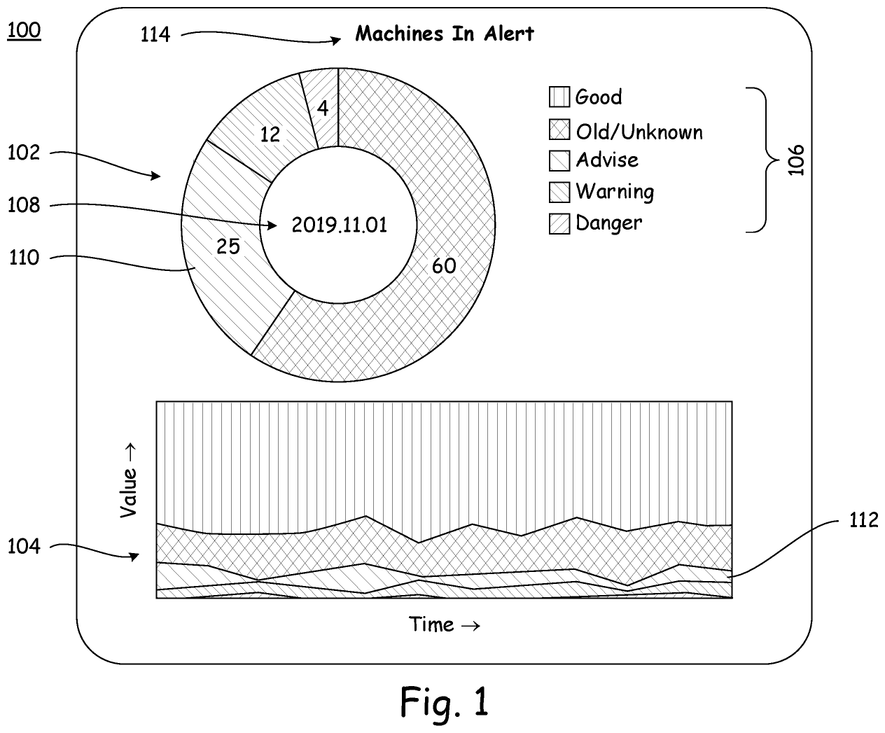

With reference now to FIG. 1, there is depicted a graphical representation of a composite interface element 100 that presents two views of a given KPI as entitled at 114, and which includes graphical representations of both a current value 102 of the KPI and the historical values 104 of the KPI. A legend 106 indicates what the various segments 110 of the current value 102 and the historical values 104 represent. An indicator 108 depicts the time at which the presented current value 102 was read, and can include information such as the date and exact time of day, as selectively desired.

In the example as presented in FIG. 1, the KPI 114 is the “machines in alert,” meaning those machines that are reporting some kind of an alert mode. It is appreciated that many other KPIs 114 could be selected and configured by the engineer, and this KPI is representative only. In the legend 106 it is seen that the various categories for this KPI 114 are “good,” “old or unknown,” “advise,” “warning,” and “danger.” It is appreciated that many other categories of alert mode could be selected and configured by the engineer, and these categories are representative only.

The graphical representation of the current value 102 of the given KPI 114 is present in this embodiment as a donut chart, where the various segments of the donut are divided according to the relative numbers of each category. It is appreciated that in other embodiments, other types of chart can be presented, like a pie chart, such as could be selected by the engineer, and this type of chart is representative only.

In this specific embodiment, the category of machines that exhibit a status of “good” is selectively omitted from the donut chart, as it would often be the largest category by a wide margin, and would thus diminish the resolution with which the other categories could be viewed. In other embodiments, the “good” category is not omitted, or can be toggled off and on as desired. In some embodiments any one or more of the categories can be toggled off or on (depicted in the donut chart or not depicted in the donut chart) as desired.

While the current value 102 depicts the value of the KPI at a specific point in time, the historical value 104 depicts the history of the KPI over a selectable period of time. In the embodiment of FIG. 1, the historical value 104 is depicted with a stacked trend chart, although it is appreciated that in other embodiments other chart types are selectively presented, such as by the engineer, and that this is representative only. In some embodiments, time is depicted along the X axis of the trend chart 104, and the various values of the categories of the KPI at a given point in time are depicted along the Y axis. In some embodiments, older values of the KPI 114 scroll off the end of the historical KPI value 104 as new current KPI values are added to the historical chart 104.

The presentation of the segment 110 in the graphical depiction of the current value 102 is keyed in some manner to both the legend 106 and the presentation of the layer 112 in the graphical depiction of the historical value 104, so that both the historical trend and the current value of the represented category can readily be seen and identified. This can be accomplished in a variety of different ways, such as with the correlated hatching as depicted in FIG. 1, or with various densities of fill, or by using different colors.

In some embodiments, an engineer can select a desired one of the different segments 110 on the current value 102 to navigate to more detailed information in regard to the status associated with the segment 110, such as a list of all machines that currently exhibit the status represented by the selected segment 110.

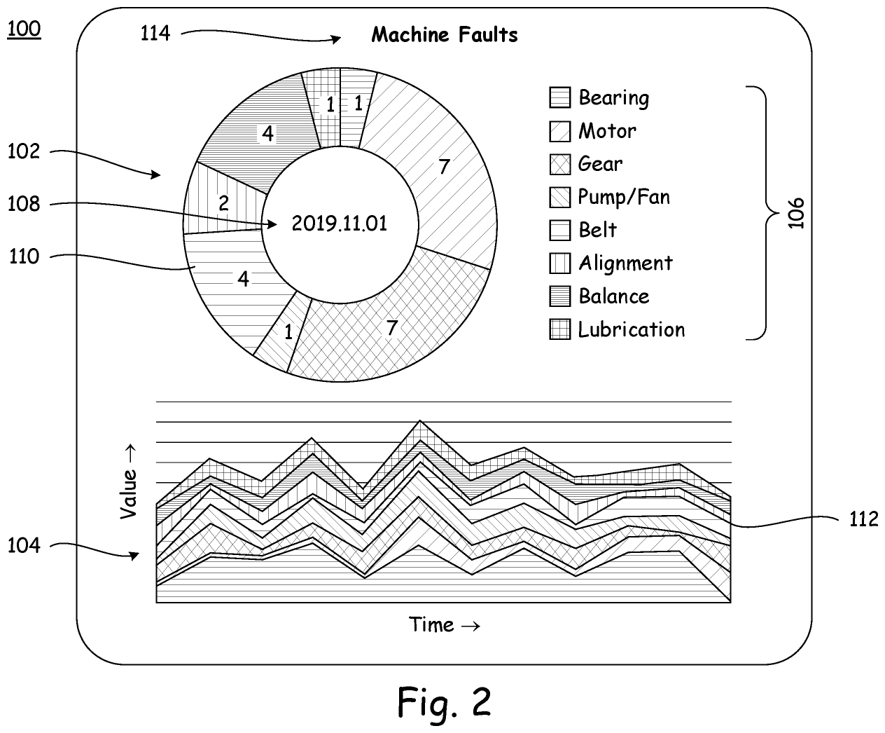

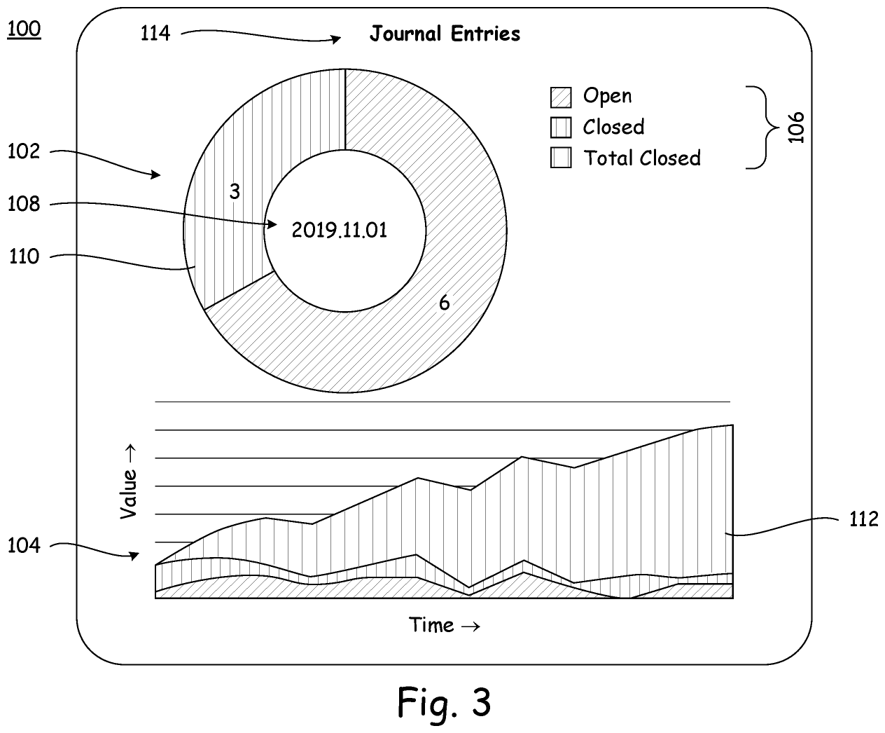

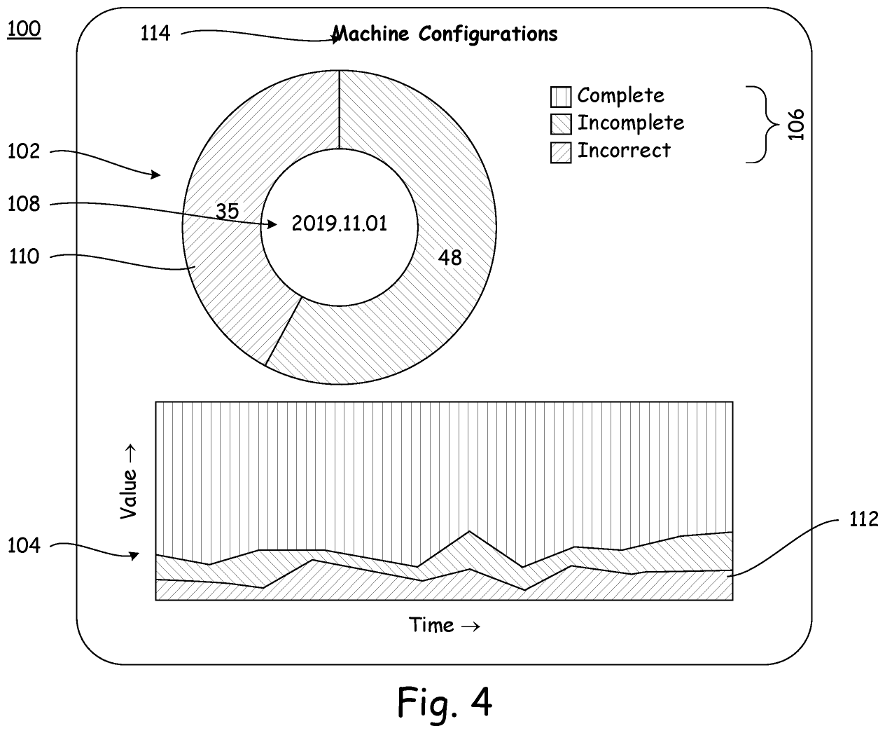

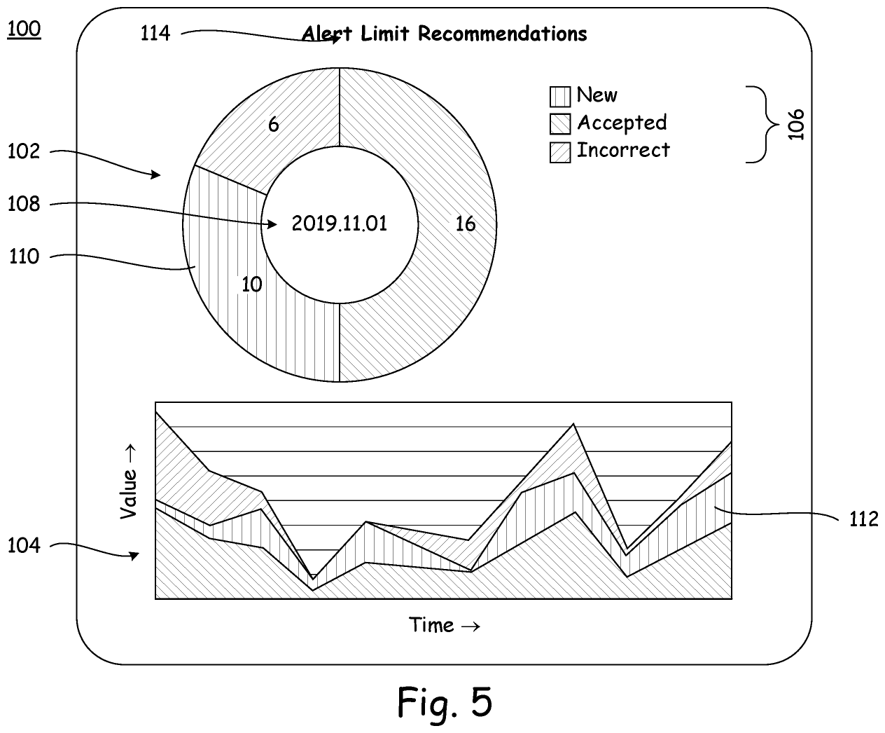

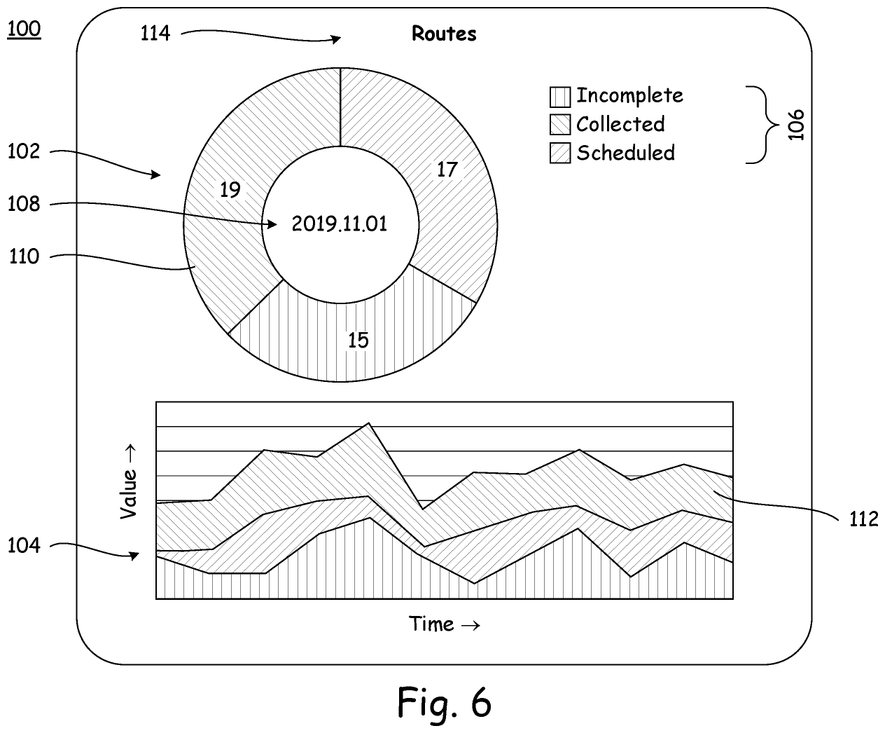

The composite interface element 100 is presented to the engineer such as on a display device, like a computer monitor, within a graphical interface for the computing system. A variety of composite interface elements 100 can be positioned in the presentation, such as for a selection of different KPIs 114, and other data presentations, according to the desires of the engineer configuring the graphical interface. For example, FIGS. 2-6 depict composite interface elements 100 for other KPIs 114.

By selecting a given point along the time-line of the historical display 104 of a given KPI 114, the presentation of the current KPI 102 is changed to depict the value of the KPI 114 that was current at the selected point in time, and the time indication 108 is respectively updated to indicate that point in time. In this manner, the engineer is able to conveniently view the historical trends of the 104 of the KPI 114, the on-going current value 102 of the KPI 114, and go back in time, so to speak, to view the then-current value 102 of the KPI 114 that was current at a given point in time 108, by selecting that point on the historical depiction 104. Thus, the engineer is able to quickly visualize and analyze current and historical trends of the KPI 114, because of the interaction between the depictions of the historical values 104 and the depictions of the current values 102 as provided by the composite interface element 100.

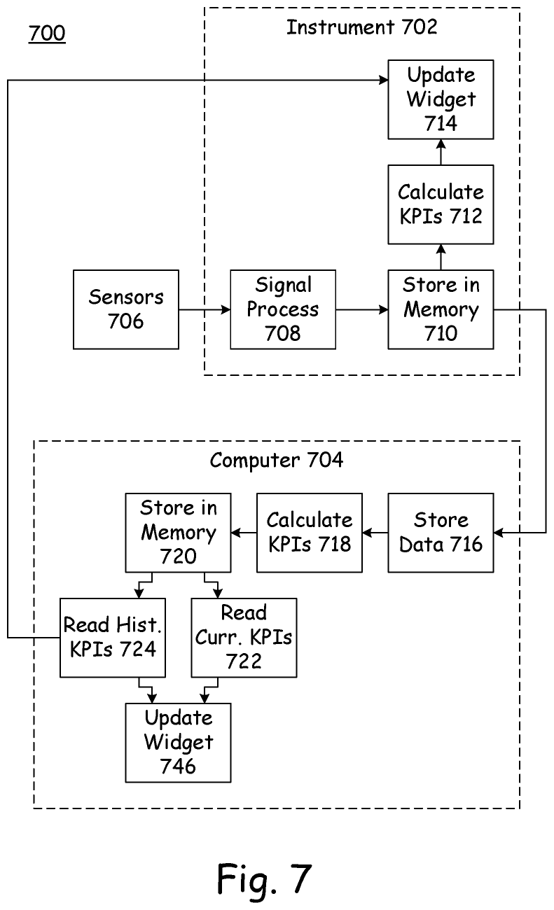

With reference now to FIG. 7, there is depicted a flow-chart of the method 700 by which the KPI 114 composite interface element 100 functions. In various embodiments, the method 700 can be instantiated in one or both of a monitoring instrument 702, such as a vibration monitor, and a computer 704, such as a server. More detail in regard to the instrument 702 and the computer 704 is provided hereafter.

The method 700 starts with gathering data about the operation of the machine from one or more sensors, as given in block 706. In the embodiment depicted, the sensors provide information directly to the instrument 702, which processes the raw signals from the sensors, as given in block 708. These processed signals are then stored in a memory, as given in block 710. A processor then calculates the various desired KPIs 114, as given in block 712. It is appreciated that some of the KPIs 114 can be read directly from the processed data received from the sensors, but others of the KPIs 114 must be calculated or otherwise derived from various inputs and sensors of different types. Once the KPIs 114 are calculated, they can then be presented as a composite interface element 100 on a display of the instrument 702, as given in block 714.

In a further embodiment, the processed data that is stored in the memory as given in block 710 can be read by a computer 704, or sent to the computer 704, or otherwise copied to and stored in the computer 704, as given in block 716. The computer 704 can also, or alternately, calculate the KPIs 114, as given in block 718, and store them in a memory in the computer, as given in block 720. These current KPIs 114 are stored along with historical KPIs 114 in the computer 704 memory. The current KPIs 114 are read from the memory as given in block 722 and the historical KPIs 114 are read from the memory as given in block 724, and are used to update the composite interface element 100 as presented by the computer 704, as given in block 746. In some embodiments the historical KPIs 114 as read in block 724 are also transmitted to the instrument 702 for presentation in the composite interface element, as given in block 714.

In a broader but more functional sense, in one embodiment the data is written to a hard drive, and certain pieces of the data are read by a processor into a RAM, where the KPIs are calculated, and then are written back to a memory in association with a time stamp. The current KPI is displayed in one graphic, and historical values of the KPI are displayed in another graphic. When the engineer clicks on a historical position in the historical KPI graphic, the time stamp of the KPI associated with that position is read, and the individual KPI associated with the time stamp is retrieved from either the hard drive or the memory, and displayed using the current KPI graphic within the composite interface element. The time stamp associated with the selected KPI is optionally displayed as well, as indicated above.

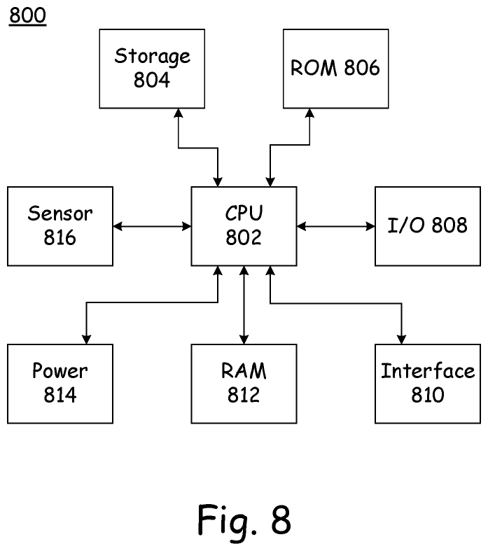

With reference now to FIG. 8, there is depicted one embodiment of a computerized apparatus 800 capable of performing the actions as described herein. In this embodiment, the apparatus 800 is locally under the control of the central processing unit 802, which controls and utilizes the other modules of the apparatus 800 as described herein. As used herein, the word module refers to a combination of both software and hardware that performs one or more designated function. Thus, in different embodiments, various modules might share elements of the hardware as described herein, and in some embodiments might also share portions of the software that interact with the hardware.

The embodiment of apparatus 800 as depicted in FIG. 8 includes, for example, a storage module 804 such as a hard drive, tape drive, optical drive, or some other relatively long-term data storage device. A read-only memory module 806 contains, for example, basic operating instructions for the operation of the apparatus 800. An input-output module 808 provides a gateway for the communication of data and instructions between the apparatus 800 and other computing devices, networks, or data storage modules. An interface module 810 includes, for example, keyboards, speakers, microphones, cameras, displays, mice, and touchpads, and provides means by which the engineer can observe and control the operation of the apparatus 800.

A random-access memory module 812 provides short-term storage for data that is being buffered, analyzed, or manipulated and programming instructions for the operation of the apparatus 800. A power module 814 is also provided in various embodiments of the apparatus 800. In some embodiment that power module 814 is a portable power supply, such as one or more batteries. In some embodiments the power module 814 includes a renewable source, such as a solar panel or an inductive coil that are configured to provide power or recharge the batteries. In other embodiments the power module 814 receives power from an external power source, such as a 110/220 volt supply.

Some embodiments of the apparatus 800 include the sensor 816, such as a vibration sensor, which senses vibration from the machine and provides the vibration signal representing the sensed vibration. For example, an amplified accelerometer is used as the sensor 816 in some embodiments.

In one embodiment, the apparatus 800 receives stored data through the input/output 808. In other embodiments, the apparatus 800 receives data from the sensor 816. In either embodiment, the apparatus 800 performs the functions as described herein, and then sends the data out through the input/output 808 for remote storage or further processing, or directly to the storage module 804. In some embodiments the steps of the method as described herein are embodied in a computer language on a non-transitory medium that is readable by the apparatus 800 of FIG. 8, and that enables the apparatus 800 to implement the process as described herein.

The apparatus 800 as depicted and described can be one or both of the instrument 702 and the computer 704, or various elements of the apparatus 800 as described can be distributed across the instrument 702 and the computer 704.

The foregoing description of embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A method of presenting data, the method comprising the steps of:
receiving data from a data source,
storing the data on a non-transient, computer-readable storage medium,
calculating a current key performance indicator from the data,
adding the current key performance indicator to a file of historical key performance indicators that is stored on the non-transient, computer-readable storage medium,
reading the current key performance indicator from the non-transient, computer-readable storage medium,
presenting the current key performance indicator in a first graphical image, reading the historical key performance indicators from the non-transient, computer-readable storage medium,
presenting the historical key performance indicators in a second graphical image, and
linking the presentation of the current key performance indicator to the presentation of the historical key performance indicators in a composite interface element, such that when a historical position is selected in the second graphical image, the first graphical image depicts a key performance indicator that was current at that historical position.

2. The method of claim 1, wherein the data is at least one of vibration, pressure, temperature, volume, speed, sound, and flow.

3. The method of claim 1, wherein the key performance indicator is at least one of machines in alert, machine faults, journal entries, machine configurations, alert limit recommendations, and routes.

4. The method of claim 1, wherein the key performance indicator depicts a selection of key performance indicator statuses.

5. The method of claim 1, wherein the first graphical image is a donut chart.

6. The method of claim 1, wherein the second graphical image is a stacked trend chart.

7. The method of claim 1, wherein the method is embodied in a portable vibration analyzer.

8. A non-transitory, computer-readable storage medium having stored thereon a computer program comprising a set of instructions for causing a computer to present data by performing the steps of:
receiving data from a data source,
storing the data on a non-transient, computer-readable storage medium,
calculating a current key performance indicator from the data,
adding the current key performance indicator to a file of historical key performance indicators that is stored on the non-transient, computer-readable storage medium,
reading the current key performance indicator from the non-transient, computer-readable storage medium,
presenting the current key performance indicator in a first graphical image,
reading the historical key performance indicators from the non-transient, computer-readable storage medium,
presenting the historical key performance indicators in a second graphical image, and
linking the presentation of the current key performance indicator to the presentation of the historical key performance indicators in a composite interface element, such that when a historical position is selected in the second graphical image, the first graphical image depicts a key performance indicator that was current at that historical position.

9. The storage medium of claim 8, wherein the data is at least one of vibration, pressure, temperature, volume, speed, sound, and flow.

10. The storage medium of claim 8, wherein the key performance indicator is at least one of machines in alert, machine faults, journal entries, machine configurations, alert limit recommendations, and routes.

11. The storage medium of claim 8, wherein the key performance indicator depicts a selection of key performance indicator statuses.

12. The storage medium of claim 8, wherein the first graphical image is a donut chart.

13. The storage medium of claim 8, wherein the second graphical image is a stacked trend chart.

14. A computerized apparatus for presenting data, the apparatus comprising:
receiving data from a data source,
a non-transient, computer-readable storage medium for storing the data,
a processor for,
calculating a current key performance indicator from the data,
adding the current key performance indicator to a file of historical key performance indicators that is stored on the non-transient, computer-readable storage medium,
reading the current key performance indicator from the non-transient, computer-readable storage medium,
a display for presenting the current key performance indicator in a first graphical image,
the processor further for reading the historical key performance indicators from the non-transient, computer-readable storage medium,
the display further for presenting the historical key performance indicators in a second graphical image, and
the processor further for linking the presentation of the current key performance indicator to the presentation of the historical key performance indicators in a composite interface element, such that when a historical position is selected with a user interface in the second graphical image, the first graphical image depicts a key performance indicator that was current at that historical position.

15. The computerized apparatus of claim 14, wherein the data is at least one of vibration, pressure, temperature, volume, speed, sound, and flow.

16. The computerized apparatus of claim 14, wherein the key performance indicator is at least one of machines in alert, machine faults, journal entries, machine configurations, alert limit recommendations, and routes.

17. The computerized apparatus of claim 14, wherein the key performance indicator depicts a selection of key performance indicator statuses.

18. The computerized apparatus of claim 14, wherein the first graphical image is a donut chart.

19. The computerized apparatus of claim 14, wherein the second graphical image is a stacked trend chart.

20. The computerized apparatus of claim 14, wherein the user interface includes a mouse.
